(19) United States
(12) Patent Application Publication
(10) Pub. No.: US 2026/0110894 A1
(43) Pub. Date: Apr. 23, 2026

(54) DOUBLE LENS-BARREL DEVICE

(71) Applicant: Asia Optical Co., Inc., Taichung (TW)

(72) Inventors: Yue-Ye Chen, ShenZhen City (CN); Yao Pei, ShenZhen City (CN); Yi-Ming Zheng, ShenZhen City (CN); Sheng Luo, ShenZhen City (CN); Hua-Tang Liu, Taichung (TW); Chih-Huang Huang, Taichung (TW); Jen-Yu Lin, Taichung (TW); Chiao-Hsia Huang, Taichung (TW); Tsung-Ming Yang, Taichung (TW)

(21) Appl. No.: 19/348,942

(22) Filed: Oct. 3, 2025

(30) Foreign Application Priority Data
Oct. 17, 2024 (CN) 202411456086.9

(51) Int. Cl. G02B 23/18; G01C 3/04; G02B 23/02

(52) U.S. Cl. CPC G02B 23/18; G01C 3/04; G02B 23/02

(57) ABSTRACT

A double lens-barrel device includes a first lens barrel, a second lens barrel, an intermediate connecting portion and a distance detecting element. The intermediate connecting portion is disposed between the first lens barrel and the second lens barrel. The first lens barrel is fixed to the intermediate connecting portion. The second lens barrel is movable with respect to the intermediate connecting portion for changing the distance between the first lens barrel and the second lens barrel. The distance detecting element is only disposed between the second barrel portion and the intermediate connecting portion to detect a change of distance between a first optical axis of the first lens barrel and a second optical axis of the second lens barrel. The first optical axis and the second optical axis are perpendicularly connected to a reference line.

### BACKGROUND OF THE INVENTION

### Field of the Invention

The invention relates to an optical device, and more particularly to a double lens-barrel device.

### Description of the Related Art

With the rapid development of optics-related technology, double lens-barrel devices (such as binocular rangefinders and binoculars) have entered the lives of many consumers. A common double lens-barrel device can be adjusted to fit different users by rotating the left and right barrels with respect to each other to adjust the interpupillary distance (IPD) therebetween. However, a conventional double lens-barrel device cannot automatically detect IPD, or the detection method is very complex so that the manufacturing cost of the double lens-barrel device is high. Further, a conventional double lens-barrel device has a display screen fixed in the barrels. When users adjust the IPD of the double lens-barrel device to fit their individual eye width, the display screen may tilt so that the viewing experience is poor.

### BRIEF SUMMARY OF THE INVENTION

The invention provides a double lens-barrel device to address the technical problem described above, wherein the double lens-barrel device of the invention is able to automatically detect IPD and adjust the display.

The double lens-barrel device in accordance with an exemplary embodiment of the invention includes a first lens barrel, a second lens barrel, an intermediate connecting portion and a distance detecting element. The first lens barrel includes a first optical axis, a first barrel portion, and a first connecting portion connected to the first barrel portion. The second lens barrel includes a second optical axis, a second barrel portion, and a second connecting portion connected to the second barrel portion. The intermediate connecting portion is disposed between the first lens barrel and the second lens barrel. The distance detecting element is only disposed between the second barrel portion and the intermediate connecting portion to detect a change of distance between the first optical axis and the second optical axis. The first connecting portion of the first lens barrel is connected to the intermediate connecting portion. The second connecting portion of the second lens barrel is connected to and movable with respect to the intermediate connecting portion for changing the distance between the first optical axis and the second optical axis. The first optical axis and the second optical axis are perpendicularly connected to a reference line.

In another exemplary embodiment, the double lens-barrel device includes a first lens barrel, a second lens barrel, an intermediate connecting portion and a distance detecting element. The first lens barrel includes a first optical axis, a first barrel portion, and a first connecting portion connected to the first barrel portion. The second lens barrel includes a second optical axis, a second barrel portion, and a second connecting portion connected to the second barrel portion. The intermediate connecting portion is disposed between the first lens barrel and the second lens barrel. The distance detecting element is only disposed between the second barrel portion and the intermediate connecting portion to detect a change of distance between the first optical axis and the second optical axis. The first connecting portion of the first lens barrel is connected to the intermediate connecting portion. The second connecting portion of the second lens barrel is connected to and movable with respect to the intermediate connecting portion for changing the distance between the first optical axis and the second optical axis. The distance detecting element includes a first element fixed to the intermediate connecting portion, and a second element fixed to the second lens barrel. The first element and the second element have surfaces disposed toward each other, one of the surfaces is provided with a transmitting portion and receiving portions and the other surface is provided with at least one reflective region. Light transmitted from the transmitting portion is reflected by the reflective region and received by the receiving portions.

In yet another exemplary embodiment, the transmitting portion includes a light source. The number of the receiving portions is at least two. The receiving portions are disposed at two sides of the transmitting portion. The light transmitted from the transmitting portion and reflected by the reflective region is received by different receiving portions.

In another exemplary embodiment, data of the light received by the receiving portions are changed when a relative position of the first lens barrel and the second lens barrel is changed.

In yet another exemplary embodiment, there are a plurality of reflective regions provided on the other surface. The plurality of reflective regions are formed by spraying a diffuse reflective layer on the other surface. The plurality of reflective regions are sequentially arranged in a relative movement direction of the first lens barrel and the second lens barrel. Reflectivities of adjacent reflective regions are different. The reflectivities of the reflective regions progressively increase in the relative movement direction of the first lens barrel and the second lens barrel.

In another exemplary embodiment, there are a plurality of reflective regions provided on the other surface. The plurality of reflective regions are formed by spraying a diffuse reflective layer on the other surface. The plurality of reflective regions are sequentially arranged in a relative movement direction of the first lens barrel and the second lens barrel. Reflectivities of adjacent reflective regions are different. The reflectivities of the reflective regions progressively decrease in the relative movement direction of the first lens barrel and the second lens barrel.

In yet another exemplary embodiment, there are a plurality of reflective regions provided on the other surface. The plurality of reflective regions are formed by spraying a diffuse reflective layer on the other surface. The plurality of reflective regions are sequentially arranged in a relative movement direction of the first lens barrel and the second lens barrel. Reflectivities of adjacent reflective regions are different. In the relative movement direction of the first lens barrel and the second lens barrel, a part of the reflective regions has the reflectivities progressively increased and another part of the reflective regions has the reflectivities progressively decreased.

In another exemplary embodiment, the double lens-barrel device further includes a controller and a circuit board. The controller is electrically connected to the transmitting portion and the receiving portion. The circuit board is disposed in the double lens-barrel device and electrically connected to the controller. The second lens barrel is linearly movable with respect to the intermediate connecting portion, so as to be close to or away from the intermediate connecting portion.

In yet another exemplary embodiment, the first lens barrel and the second lens barrel is rotatable with respect to each other about a relative rotation axis. The receiving portions are located on a circumference centered on the relative rotation axis. The reflective regions are all in shape of annular sector and located on the circumference centered on the relative rotation axis.

In another exemplary embodiment, the double lens-barrel device includes a first lens barrel, a second lens barrel, an intermediate connecting portion and a distance detecting element. The first lens barrel includes a first optical axis, a first barrel portion, and a first connecting portion connected to the first barrel portion. The second lens barrel includes a second optical axis, a second barrel portion, and a second connecting portion connected to the second barrel portion. The intermediate connecting portion is disposed between the first lens barrel and the second lens barrel. The distance detecting element is only disposed between the second barrel portion and the intermediate connecting portion to detect a change of distance between the first optical axis and the second optical axis. The first connecting portion of the first lens barrel is connected to the intermediate connecting portion. The second connecting portion of the second lens barrel is connected to and movable with respect to the intermediate connecting portion for changing the distance between the first optical axis and the second optical axis. The distance detecting element includes a sensor disposed on the second lens barrel and configured to detect a rotation angle of the second lens barrel with respect to a reference line. The reference line is perpendicularly connected to the first optical axis and the second optical axis and parallel to the horizon.

In yet another exemplary embodiment, the double lens-barrel device further includes a display and a controller. The display is disposed in the second lens barrel or in the first lens barrel. The controller is configured for receiving the rotation angle of the second lens barrel with respect to the reference line from the sensor, and for calculating an angle at which an image shown by the display is required to be rotated in a direction opposite to a rotational direction of the second lens barrel. The rotation angle of the second lens barrel with respect to the reference line is obtained from the sensor when the reference line is parallel to the horizon.

In another exemplary embodiment, the double lens-barrel device further includes a user command interface for receiving user instructions to rotate the image and transmitting the user instructions to the controller.

In yet another exemplary embodiment, the display is a matrix display.

In another exemplary embodiment, the image shown by the display includes a plurality of pixels which are individually controlled.

In yet another exemplary embodiment, the image shown by the display is rotated by replacing pixel data at adjusted coordinates with those at original coordinates in accordance with the following formulas:

$${x}^{′} = cos ( Δθ ) \cdot x - sin ( Δθ ) \cdot y ;$$

$${y}^{′} = sin ( Δθ ) \cdot x + cos ( Δθ ) \cdot y ;$$

$$Δθ = θ 1 + θ 2 ;$$

where x′ and y′ are the adjusted coordinates of the pixels, x and y are the original coordinates of the pixels, θ1 is an angle between a vector corresponding to the adjusted coordinates x′ and y′ and a vector corresponding to the original coordinates x and y, and θ2 is an angle between a vector corresponding to the original coordinates x and y and an x-axis.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view showing the structure of a double lens-barrel device in accordance with a first embodiment of the invention.

FIG. 2 is another schematic view showing the structure of the double lens-barrel device in accordance with the first embodiment of the invention.

FIG. 3 is another schematic view showing the structure of the double lens-barrel device in accordance with the first embodiment of the invention.

FIG. 4 is a schematic view showing the structure of the distance detecting element of the double lens-barrel device in accordance with the first embodiment of the invention.

FIG. 5 is an exploded view schematically showing the distance detecting element of the double lens-barrel device in accordance with the first embodiment of the invention.

FIG. 6 is a schematic view of the first element and the second element, corresponding to the relative positions of the first lens barrel and the second lens barrel from the first position to the fifth position in accordance with the first embodiment of the invention.

FIG. 7 is a schematic view showing the structure of a double lens-barrel device according to a third embodiment of the invention.

FIG. 8 is a schematic view showing a rotated image in accordance with the third embodiment of the invention.

FIG. 9 is a flowchart of adjusting the image in accordance with the third embodiment of the invention.

FIGS. 10A and 10B are schematic views, respectively showing the tilt angle of a display that is detected and a position conversion on pixels of the displayed data in accordance with the third embodiment of the invention.

### DETAILED DESCRIPTION OF THE INVENTION

The purpose, technical scheme and merits of the invention can be more fully understood by reading the subsequent detailed description and embodiments with references made to the accompanying drawings. However, it is understood that the subsequent detailed description and embodiments are only used for describing the invention. The invention is not limited thereto.

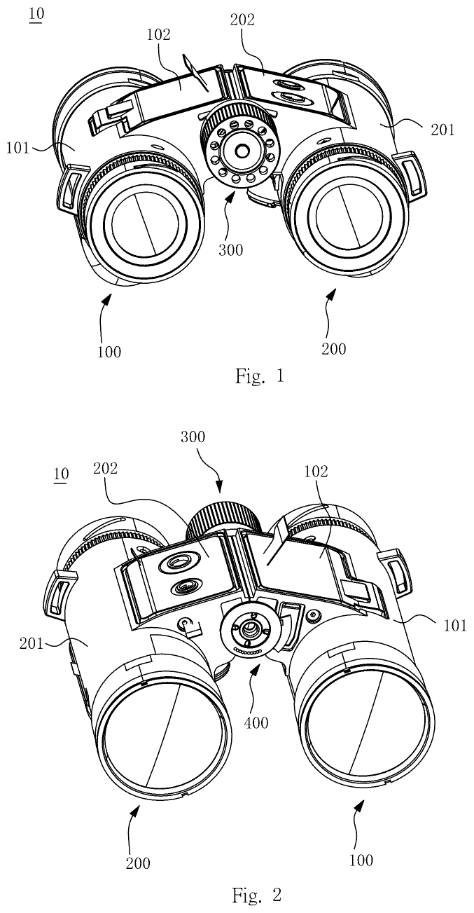

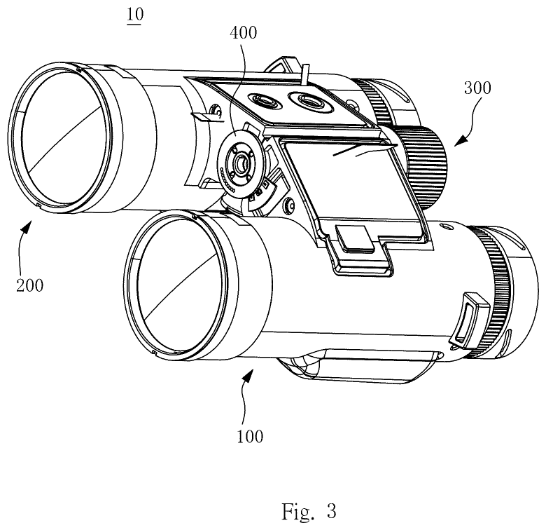

FIG. 1 is a schematic view showing the structure of a double lens-barrel device 10 in accordance with a first embodiment of the invention; FIG. 2 is another schematic view showing the structure of the double lens-barrel device 10 in accordance with the first embodiment of the invention; and FIG. 3 is another schematic view showing the structure of the double lens-barrel device 10 in accordance with the first embodiment of the invention. Referring to FIGS. 1-3, the double lens-barrel device 10 of the invention may be binoculars, binocular rangefinders or the like, including a first lens barrel 100, a second lens barrel 200, and an intermediate connecting portion 300 disposed therebetween. The intermediate connecting portion 300 is a shaft element. The first lens barrel 100 is fixedly connected to the intermediate connecting portion 300. The second lens barrel 200 is rotatable about the intermediate connecting portion 300 for adjusting the interpupillary distance (IPD) between the first lens barrel 100 and the second lens barrel 200 so that the double lens-barrel device 10 can fit different users.

In the illustrated embodiment, the right telescope barrel is used as the first lens barrel 100 for description, but the invention is not limited thereto. The first lens barrel 100 includes a first barrel portion 101 and a first connecting portion 102 fixedly connected to the first barrel portion 101. The first barrel portion 101 has a first optical axis and a first center point Ca (see FIG. 7), wherein the first center point Ca is located on the first optical axis. The second lens barrel 200 includes a second barrel portion 201 and a second connecting portion 202 fixedly connected to the second barrel portion 201. The second barrel portion 201 has a second center point Cb, wherein the second center point Cb is located on the second optical axis. The intermediate connecting portion 300 may be cylindrical, such as a cylinder with a uniform diameter or a stepped cylinder with varying diameters. The intermediate connecting portion 300 has a central axis and a connection center point C, wherein the connection center point C is located on the central axis. The first connecting portion 102 is fixedly connected to the intermediate connecting portion 300. The second connecting portion 202 is rotatably connected to the intermediate connecting portion 300 and can be moved with respect to the intermediate connecting portion 300 to change the distance between the first optical axis and the second optical axis. The first connecting portion 102 and the second connecting portion 202 are shaped to match the outer surface of the intermediate connecting portion 300 at the connection therebetween, for example, in the shape of inwardly concave arc.

It is worth noting that the first center point Ca, the second center point Cb, and the connection center point C are points on the first optical axis of the first barrel portion 101, the second optical axis of the second barrel portion 201, and the central axis of the intermediate connecting portion 300, respectively. The first center point Ca, the second center point Cb, and the connection center point C are located on the same plane, namely on a cross-sectional plane of the first barrel portion 101, the second barrel portion 201, and the intermediate connecting portion 300 that is perpendicular to the first optical axis, the second optical axis, and the central axis. In the embodiment shown in FIG. 1, the connection center point C is located outside a line which connects the first center point Ca and the second center point Cb. Specifically, the connection center point C is located above the line.

A first end of the intermediate connecting portion 300 extends beyond the first lens barrel 100 and the second lens barrel 200. A distance detecting element 400 is provided between the intermediate connecting portion 300 and the second lens barrel 200. The distance detecting element 400 is used to detect the change of distance between the first optical axis and the second optical axis and is only provided between the second barrel 201 and the intermediate connecting portion 300.

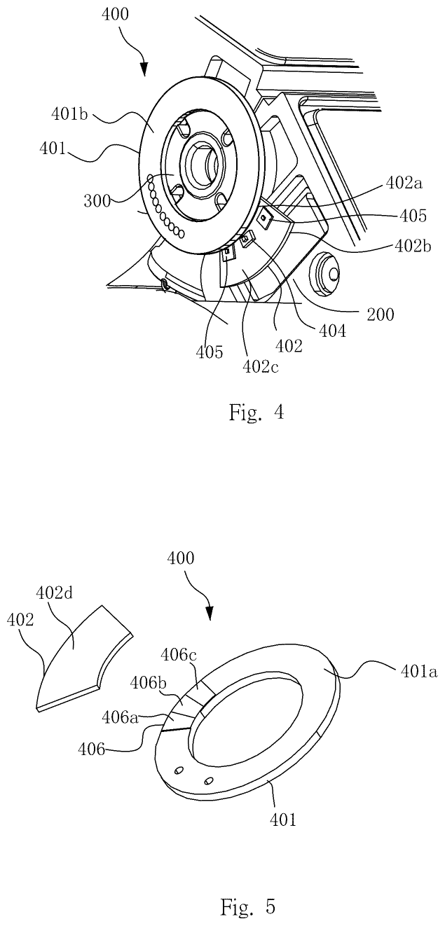

FIG. 4 is a schematic view showing the structure of the distance detecting element 400 of the double lens-barrel device 10 in accordance with the first embodiment of the invention, and FIG. 5 is an exploded view schematically showing the distance detecting element 400 of the double lens-barrel device 10 in accordance with the first embodiment of the invention. As shown in FIGS. 1-5, the distance detecting element 400 includes a first element 401 fixed to the intermediate connecting portion 300, and a second element 402 fixed to the second lens barrel 200. When the first lens barrel 100 and the second lens barrel 200 are moved with respect to each other, the first element 401 and the second element 402 are also moved with respect to each other.

Specifically, the first element 401 is substantially plate-shaped and is fixedly disposed around the outer periphery of the first end of the intermediate connecting portion 300, with its centerline coinciding with the central axis of the intermediate connecting portion 300. In a preferred embodiment, the first element 401 is annular and fixed to the outer periphery of the first end of the intermediate connecting portion 300 by gluing or interference fit. The first element 401 includes a first surface 401a and a second surface 401b opposite to the first surface 401a, wherein the first surface 401a faces the first connecting portion 102 of the first lens barrel 100 and the second connecting portion 202 of the second lens barrel 200.

The second element 402 is fixed to the second lens barrel 200. The first element 401 and the second element 402 are arranged along the relative rotation axis of the first lens barrel 100 and the second lens barrel 200 to face each other. The relative rotation axis is the central axis of the intermediate connecting portion 300. The second element 402 is plate-shaped, circumferentially extended with respect to the relative rotation axis, and configured to cover at least a portion of an end of the second connecting portion 202 of the second lens barrel 200. In a preferred embodiment, the second element 402 includes an arcuate inner surface 402a and an outer surface 402b. The inner surface 402a is circumferentially extended with respect to the intermediate connecting portion 300. The outer surface 402b is disposed opposite to the arcuate inner surface 402a, namely the outer surface 402b is disposed apart from the arcuate inner surface 402a in a radial direction perpendicular to the relative rotation axis. The outer surface 402b is preferably arcuate. The outer surface 402b and the inner surface 402a are coaxial. The common axis of the outer surface 402b and the inner surface 402a is the relative rotation axis. The second element 402, if sectioned with a plane in a direction perpendicular to the relative rotation axis, has a section in the shape of annular sector.

The second element 402 further includes a third surface 402c disposed toward the first element 401, and a fourth surface 402d disposed opposite to the third surface 402c. The second element 402 is fixed to the second lens barrel 200 through the fourth surface 402d. In the illustrated embodiment, the second lens barrel 200 has a cylindrical structure that is disposed around the intermediate connecting portion 300, and the second element 402 may be fixed to the cylindrical structure through its inner surface 402a. However, the invention is not limited thereto.

The first element 401 and the second element 402 have surfaces disposed toward each other, one of the surfaces is provided with a transmitting portion 404 and receiving portions 405 and the other surface is provided with a reflective surface 406. The double lens-barrel device 10 further includes a circuit board disposed therein and a controller electrically connected to the circuit board. The transmitting portion 404 and the receiving portions 405 are electrically connected to the circuit board and the controller. Light emitted by the transmitting portion 404 is reflected by different regions of the reflective surface 406 and then received by the receiving portions 405. The receiving portions 405 transmit data corresponding to the light amount to the controller. The controller uses the light amount to determine the relative positions of the first and second lens barrels 100, 200, and the interpupillary distance.

In the illustrated embodiment, in the relative rotation direction of the first lens barrel 100 and the second lens barrel 200, at least two receiving portions 405 are disposed on both sides of the transmitting portion 404. For example, when there are three receiving portions 405, one of the receiving portions 405 may be disposed on one side of the transmitting portion 404 and the other receiving portions 405 may be disposed on the other side of the transmitting portion 404. Preferably, multiple receiving portions 405 are located on a circumference centered on the relative rotation axis.

An example is taken as a representative in the following descriptions, in which the reflective surface 406 is provided on the first element 401. The reflective surface 406 sequentially includes a plurality of reflective regions arranged in the relative rotation direction of the first lens barrel 100 and the second lens barrel 200, and centered on the relative rotation axis. The number of the reflective regions may be at least three, and the reflectivities of adjacent reflective regions are different.

The widths of the reflective regions measured in the relative rotation direction and the distance between the receiving portions 405 measured in the relative rotation direction are required to satisfy the following conditions: different receiving portions 405 receive the reflected light from different reflective regions. Preferably, two adjacent receiving portions 405 are configured to receive the reflected light from two adjacent reflective regions, respectively.

In a preferred embodiment, the reflective regions are all in the shape of annular sector and located on a circumference centered on the relative rotation axis. The reflective regions may have the same size and shape. Preferably, the reflectivities of the reflective regions progressively increase or decrease in the relative rotation direction of the first lens barrel 100 and the second lens barrel 200. Alternatively, in the relative rotation direction of the first lens barrel 100 and the second lens barrel 200, the reflectivities of some reflective regions progressively increase, while the reflectivities of some other regions progressively decrease. For example, starting from a reflective region, each of the reflective regions have the reflectivities progressively increased in the clockwise order, while each of the reflective regions have the reflectivities progressively decreased in a counterclockwise order. However, the invention is not limited thereto. It is at least required in the invention that the data of the light amount received by different receiving portions 405 are different when the first lens barrel 100 and the second lens barrel 200 are rotated in a relative rotation direction (e.g., clockwise).

In the illustrated embodiment, there are three reflective regions, namely, the first reflective region 406a, the second reflective region 406b, and the third reflective region 406c. There are two receiving portions 405, namely, the first and second receiving portions. The reflectivities of the reflective regions 406a-406c vary sequentially (increasing or decreasing) in the relative rotation direction. Other portions outside the reflective regions 406a-406c can be blacked to have a reflectivity close to 0% that is different from the reflectivities of the reflective regions.

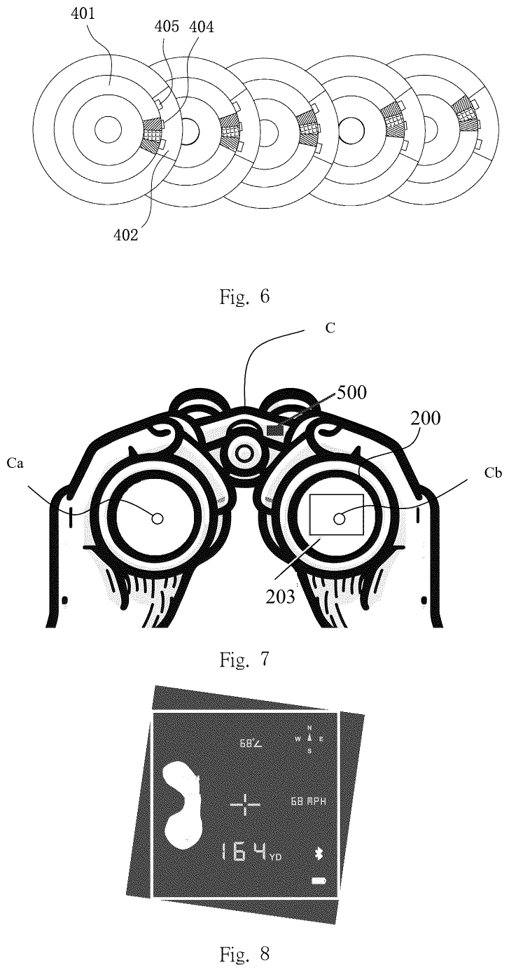

FIG. 6 is a schematic view of the first element and the second element, corresponding to the relative positions of the first lens barrel and the second lens barrel from the first position to the fifth position in accordance with the first embodiment of the invention. For ease of understanding, different reflective regions are represented by different patterns on the second surface 401b of the first element 401, and it is understood that these reflective regions should be located on the first surface 401a of the first element 401.

The reflectivities of the first to third reflective regions may be, for example, 1.71%, 15.4%, and 67.66%, respectively. When the light amount received by the first receiving portion is 1.71 and the light amount received by the second receiving portion is 67.66, it is determined that the relative position of the first lens barrel 100 and the second lens barrel 200 is the first position (zero position, i.e. the middle position in FIG. 6). When the light amount received by the first receiving portion becomes 0 and the light amount received by the second receiving portion is 15.4, it is determined that the second lens barrel 200 is rotated counterclockwise relative to the first lens barrel 100 from the first position, and the relative position of the first lens barrel 100 and the second lens barrel 200 is the second position (the second from the left in FIG. 6). When the light amount received by the first receiving portion becomes 0 and the light amount received by the second receiving portion is 1.71, it is determined that the second lens barrel 200 continues to rotate counterclockwise relative to the first lens barrel 100, and the relative position of the first lens barrel 100 and the second lens barrel 200 is the third position (the first from the left in FIG. 6).

For another example which is based on the third position, if the light amount received by the first receiving portion is 0 and the light amount received by the second receiving portion changes from 1.71 to 15.4, it is determined that the second lens barrel 200 is rotated clockwise from the third position to the second position. Other relative positions of the first lens barrel 100 and the second lens barrel 200 can be determined by analogy.

When the light amount received by the first receiving portion becomes 15.4 and the light amount received by the second receiving portion is 0, it is determined that the second lens barrel 200 rotates clockwise with respect to the first lens barrel 100 from the first position, and the relative position of the first lens barrel 100 and the second lens barrel 200 is the fourth position (the second from the right in FIG. 6). When the light amount received by the first receiving portion becomes 1.71 and the light amount received by the second receiving portion is 0, it is determined that the second lens barrel 200 continues to rotate clockwise with respect to the first lens barrel 100, and the relative position of the first lens barrel 100 and the second lens barrel 200 is the third position (the first from the right in FIG. 6).

In the above embodiment, when the first lens barrel 100 and the second lens barrel 200 rotate with respect to each other, the second element 402 rotates with respect to the first element 401, causing the transmitting portion 404 and the receiving portion 405 to rotate accordingly. The light emitted by the transmitting portion 404 is reflected by different reflective regions before and after the rotation, and the light amount received by the receiving portion 405 changes before and after the rotation. Based on the light amount received by the receiving portion 405 or the changed trend of the received light amount, the controller can determine the positions of the first lens barrel 100 and the second lens barrel 200, thereby achieving the pupillary distance detection.

In another embodiment, there are one reflective region and two receiving portions 405. The two receiving portions 405 are the first receiving portion and the second receiving portion, respectively. Other portions outside the reflective region can be blacked to have a reflectivity close to 0% that is different from the reflectivity of the reflective region. For example, the reflectivity of the reflective region is 60%. When the light amount received by the first receiving portion gradually decreases from 60% and the light amount received by the second receiving portion gradually increases, it is determined that the second lens barrel 200 is rotated with respect to the first lens barrel 100 in a direction which causes the first receiving portion to gradually move away from the reflective region and the second receiving portion to gradually move closer to the reflective region. If the first receiving portion and the second receiving portion are arranged in a clockwise direction, it is further determined that the second lens barrel 200 is rotated clockwise with respect to the first lens barrel 100, and vice versa.

Further, a range of pupillary distance instead of the pupillary distance can be set for use. For example, when the light amount received by the first receiving portion is 60 and the light amount received by the second receiving portion is 0, the range of the pupillary distance is correspondingly set as a first range. When the light amount received by the first receiving portion is 0 and the light amount received by the second receiving portion is 60, the range of the pupillary distance is correspondingly set as a second range. It is understood that a finer range can be set for use.

It is therefore understood that the number of reflective regions is not limited in the invention. The positions of the first lens barrel 100 and the second lens barrel 200 are determined in accordance with the changed trend of the light received by the receiving portion so as to achieve pupillary distance detection.

In the first embodiment described above, the first lens barrel 100 and the second lens barrel 200 are rotatable with respect to each other to adjust the interpupillary distance. However, the invention is not limited thereto. In a second embodiment of the invention, the first lens barrel and the second lens barrel can be linearly moved with respect to each other, thereby being moved close to or away from each other to adjust the interpupillary distance. Similar to that of the first embodiment described above, the double lens-barrel device of the second embodiment of the invention includes a first lens barrel, a second lens barrel, and an intermediate connecting portion disposed therebetween. The first lens barrel is fixedly connected to the intermediate connecting portion, and the second lens barrel can be linearly moved with respect to the intermediate connecting portion so as to be close to or away from the intermediate connecting portion, wherein the connection center point can be located on a line connecting the first center point and the second center point.

In this embodiment, the distance detecting element is located only between the second barrel portion and the connection center point, and includes a first element fixed to the intermediate connecting portion and a second element fixed to the second lens barrel. The first element and the second element have surfaces disposed toward each other, one of the surfaces is provided with a transmitting portion and at least two receiving portions and the other surface is provided with a reflective surface. In the relative movement direction of the first lens barrel and the second lens barrel, at least two receiving portions are disposed on both sides of the transmitting portion. Further, the reflective surface sequentially includes a plurality of reflective regions arranged in the relative movement direction of the first lens barrel and the second lens barrel. The number of the reflective regions may be at least three, and the reflectivities of adjacent reflective regions are different.

The widths of the reflective regions measured in the relative movement direction and the distance between the receiving portions 405 measured in the relative movement direction are required to satisfy the following conditions: different receiving portions receive the reflected light from different reflective regions.

Preferably, two adjacent receiving portions are configured to receive the reflected light from two adjacent reflective regions, respectively. The reflectivities of the reflective regions can progressively increase or decrease in the relative movement direction of the first lens barrel and the second lens barrel. Alternatively, in the relative movement direction of the first lens barrel and the second lens barrel, the reflectivities of some reflective regions can increase, while the reflectivities of some other regions can decrease. However, the invention is not limited thereto. It is at least required in the invention that the data of the light amount received by different receiving portions are different when the first lens barrel and the second lens barrel are linearly moved with respect to each other in the relative movement direction (e.g. the direction in which the first lens barrel and the second lens barrel are moved close to each other).

In the above embodiments, each reflective region of the reflective surface can be produced by spraying a diffuse reflective layer on the other of the first element and the second element. The diffuse reflective layer may be, for example, a diffuse reflective white paint layer or an aluminum paint layer.

The above embodiment can automatically detect the pupillary distance so as to adjust the image provided by the first lens barrel 100 and the second lens barrel 200 according to the change of the pupillary distance. The structure is simple and does not significantly increase the overall cost.

FIG. 7 is a schematic view showing the structure of a double lens-barrel device 10 according to a third embodiment of the invention. FIG. 8 is a schematic view showing a rotated image in accordance with the third embodiment of the invention.

In the third embodiment of the invention, the distance detecting element includes a sensor 500 disposed on the second lens barrel 200. The sensor 500 is configured to detect the rotation angle of the second lens barrel 200 with respect to a reference line, wherein the reference line is perpendicularly connected to the first optical axis and the second optical axis and is parallel to the horizon. The sensor 500 is electrically connected to a controller. A display 203 for showing a display image is disposed within the second lens barrel 200. The display 203 may be, for example, a matrix display.

When the second lens barrel 200 is rotated with respect to the first lens barrel 100, the display 203 is rotated along with the second lens barrel 200 that causes a titled image shown therein. The sensor 500 detects the rotation angle of the second lens barrel 200, and the controller receives the rotation angle data from the sensor 500 for calculating the angle at which the image shown by the display 203 is required to be rotated in the opposite direction.

In the third embodiment, the display 203 for showing the display image is disposed within the second lens barrel 200. However, the invention is not limited. It is understood that the display may be disposed within the first lens barrel 100 to function the same.

The double lens-barrel device 10 is also provided with a user command interface for receiving user instructions to rotate the image and transmitting the instructions to the controller. In accordance with the instructions, the controller rotates the image shown by the display 203 at the same angle in the opposite direction, thereby offsetting the image tilt caused by the rotation of the second lens barrel 200. However, the invention is not limited to this. The controller may directly determine whether to rotate the image without receiving user instructions.

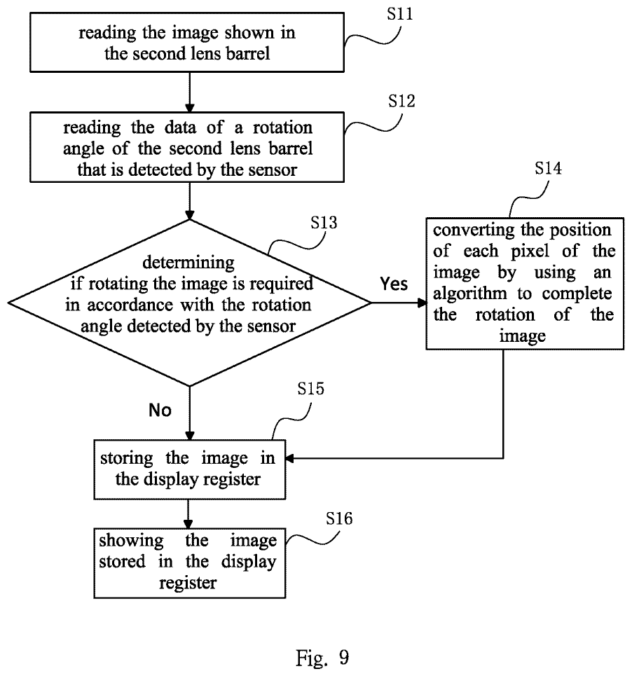

The image shown by the display includes a plurality of pixels, wherein the pixels to be shown are individually controlled when the image is adjusted (rotated). FIG. 9 is a flowchart of adjusting the image in accordance with the third embodiment of the invention. The process of adjusting the image includes the following steps:

In step S11, the image shown in the second lens barrel is read.

In step S12, the data of a rotation angle of the second lens barrel 200 is read wherein the rotation angle of the second lens barrel 200 is detected by the sensor 500.

In step S13, it is determined if rotation of the image is required in accordance with the rotation angle of the second lens barrel 200 detected by the sensor 500. When rotation of the image is required (Yes in step S13), the process goes to step S14. When rotation of the image is not required (No in step S13), the process goes to step S15.

In step S14, the position of each pixel of the image is converted by using an algorithm to complete the rotation of the image. Then, the process goes to step S15.

In step S15, the image is stored in the display register.

In step S16, the image stored in the display register is shown.

In step S14, the image is rotated in accordance with the change of tilt detected by the sensor 500.

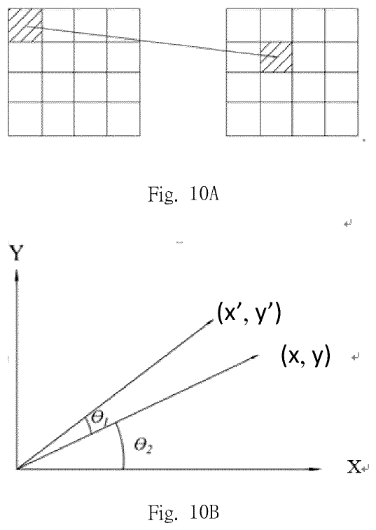

FIGS. 10A and 10B are schematic views, respectively showing the tilt angle of a display that is detected and a position conversion on pixels of the displayed data in accordance with the third embodiment of the invention. As shown in FIGS. 10A and 10B, the position conversion involves converting each pixel's coordinates to new coordinates using a vector algorithm. The algorithm is as follows:

It is assumed that the original coordinates of a pixel in the image are (x, y). The tilt angle of the image is used to determine if rotation of the original image is required. If rotation is required, the original coordinates (x, y) of the pixel are converted using an algorithm to obtain adjusted coordinates (x′, y′), and the adjusted coordinates (x′, y′) of the pixel are temporarily stored. If rotation is not required, the original display coordinates (x, y) are directly used as the adjusted coordinates (x′, y′), and the adjusted coordinates (x′, y′) are temporarily stored.

In an embodiment, the original coordinates of a pixel are (x, y), the angle between the vector corresponding to the adjusted coordinates (x′, y′) and the vector corresponding to the original coordinates (x, y) is θ1, and the angle between the vector corresponding to the original coordinates (x, y) and the x-axis is θ2. Δθ=θ1+θ2. The coordinates of the pixel after adjustment are:

x′=cos(Δθ)·x−sin(Δθ)·y;

y′=sin(Δθ)·x+cos(Δθ)·y.

The pixel data originally at (x, y) is written to (x′, y′) to achieve image rotation. That is, the pixel data at adjusted coordinates (x′, y′) are replaced with those at original coordinates (x, y) to achieve image rotation.

In the third embodiment, the shown image can be rotated and adjusted in accordance with the rotation of the second lens barrel 200, which is convenient in operation for users.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A double lens-barrel device, comprising:
a first lens barrel comprising a first optical axis, a first barrel portion, and a first connecting portion connected to the first barrel portion;
a second lens barrel comprising a second optical axis, a second barrel portion, and a second connecting portion connected to the second barrel portion;
an intermediate connecting portion disposed between the first lens barrel and the second lens barrel;
a distance detecting element only disposed between the second barrel portion and the intermediate connecting portion to detect a change of distance between the first optical axis and the second optical axis;
wherein the first connecting portion of the first lens barrel is connected to the intermediate connecting portion;
wherein the second connecting portion of the second lens barrel is connected to and movable with respect to the intermediate connecting portion for changing the distance between the first optical axis and the second optical axis;
wherein the first optical axis and the second optical axis are perpendicularly connected to a reference line.

2. A double lens-barrel device, comprising:
a first lens barrel comprising a first optical axis, a first barrel portion, and a first connecting portion connected to the first barrel portion;
a second lens barrel comprising a second optical axis, a second barrel portion, and a second connecting portion connected to the second barrel portion;
an intermediate connecting portion disposed between the first lens barrel and the second lens barrel;
a distance detecting element only disposed between the second barrel portion and the intermediate connecting portion to detect a change of distance between the first optical axis and the second optical axis;
wherein the first connecting portion of the first lens barrel is connected to the intermediate connecting portion;
wherein the second connecting portion of the second lens barrel is connected to and movable with respect to the intermediate connecting portion for changing the distance between the first optical axis and the second optical axis;
wherein the distance detecting element comprises a first element fixed to the intermediate connecting portion, and a second element fixed to the second lens barrel;
wherein the first element and the second element have surfaces disposed toward each other, one of the surfaces is provided with a transmitting portion and receiving portions and the other surface is provided with at least one reflective region;
wherein light transmitted from the transmitting portion is reflected by the reflective region and received by the receiving portions.

3. The double lens-barrel device as claimed in claim 2, wherein:
the transmitting portion comprises a light source;
the number of the receiving portions is at least two;
the receiving portions are disposed at two sides of the transmitting portion;
the light transmitted from the transmitting portion and reflected by the reflective region is received by different receiving portions.

4. The double lens-barrel device as claimed in claim 3, wherein data of the light received by the receiving portions are changed when a relative position of the first lens barrel and the second lens barrel is changed.

5. The double lens-barrel device as claimed in claim 2, wherein:
there are a plurality of reflective regions provided on the other surface;
the plurality of reflective regions are formed by spraying a diffuse reflective layer on the other surface;
the plurality of reflective regions are sequentially arranged in a relative movement direction of the first lens barrel and the second lens barrel;
reflectivities of adjacent reflective regions are different;
the reflectivities of the reflective regions progressively increase in the relative movement direction of the first lens barrel and the second lens barrel.

6. The double lens-barrel device as claimed in claim 2, wherein:
there are a plurality of reflective regions provided on the other surface;
the plurality of reflective regions are formed by spraying a diffuse reflective layer on the other surface;
the plurality of reflective regions are sequentially arranged in a relative movement direction of the first lens barrel and the second lens barrel;
reflectivities of adjacent reflective regions are different;
the reflectivities of the reflective regions progressively decrease in the relative movement direction of the first lens barrel and the second lens barrel.

7. The double lens-barrel device as claimed in claim 2, wherein:
there are a plurality of reflective regions provided on the other surface;
the plurality of reflective regions are formed by spraying a diffuse reflective layer on the other surface;
the plurality of reflective regions are sequentially arranged in a relative movement direction of the first lens barrel and the second lens barrel;
reflectivities of adjacent reflective regions are different;
in the relative movement direction of the first lens barrel and the second lens barrel, a part of the reflective regions has the reflectivities progressively increased and another part of the reflective regions has the reflectivities progressively decreased.

8. The double lens-barrel device as claimed in claim 2, further comprising:
a controller electrically connected to the transmitting portion and the receiving portion;
a circuit board disposed in the double lens-barrel device and electrically connected to the controller;
wherein the second lens barrel is linearly movable with respect to the intermediate connecting portion, so as to be close to or away from the intermediate connecting portion.

9. The double lens-barrel device as claimed in claim 2, wherein:
the first lens barrel and the second lens barrel is rotatable with respect to each other about a relative rotation axis;
the receiving portions are located on a circumference centered on the relative rotation axis;
the reflective regions are all in shape of annular sector and located on the circumference centered on the relative rotation axis.

10. A double lens-barrel device, comprising:
a first lens barrel comprising a first optical axis, a first barrel portion, and a first connecting portion connected to the first barrel portion;
a second lens barrel comprising a second optical axis, a second barrel portion, and a second connecting portion connected to the second barrel portion;
an intermediate connecting portion disposed between the first lens barrel and the second lens barrel;
a distance detecting element only disposed between the second barrel portion and the intermediate connecting portion to detect a change of distance between the first optical axis and the second optical axis;
wherein the first connecting portion of the first lens barrel is connected to the intermediate connecting portion;
wherein the second connecting portion of the second lens barrel is connected to and movable with respect to the intermediate connecting portion for changing the distance between the first optical axis and the second optical axis;
wherein the distance detecting element comprises a sensor disposed on the second lens barrel and configured to detect a rotation angle of the second lens barrel with respect to a reference line;
wherein the reference line is perpendicularly connected to the first optical axis and the second optical axis and parallel to the horizon.

11. The double lens-barrel device as claimed in claim 10, further comprising:
a display disposed in the second lens barrel or in the first lens barrel;
a controller configured for receiving the rotation angle of the second lens barrel with respect to the reference line from the sensor, and for calculating an angle at which an image shown by the display is required to be rotated in a direction opposite to a rotational direction of the second lens barrel;
wherein the rotation angle of the second lens barrel with respect to the reference line is obtained from the sensor when the reference line is parallel to the horizon.

12. The double lens-barrel device as claimed in claim 11, further comprising a user command interface for receiving user instructions to rotate the image and transmitting the user instructions to the controller.

13. The double lens-barrel device as claimed in claim 11, wherein the display is a matrix display.

14. The double lens-barrel device as claimed in claim 11, wherein the image shown by the display comprises a plurality of pixels which are individually controlled.

15. The double lens-barrel device as claimed in claim 14, wherein the image shown by the display is rotated by replacing pixel data at adjusted coordinates with those at original coordinates in accordance with the following formulas:
$${x}^{′} = cos ( Δθ ) \cdot x - sin ( Δθ ) \cdot y ;$$
$${y}^{′} = sin ( Δθ ) \cdot x + cos ( Δθ ) \cdot y ;$$
$$Δθ = θ 1 + θ 2 ;$$
where x′ and y′ are the adjusted coordinates of the pixels, x and y are the original coordinates of the pixels, θ1 is an angle between a vector corresponding to the adjusted coordinates x′ and y′ and a vector corresponding to the original coordinates x and y, and θ2 is an angle between a vector corresponding to the original coordinates x and y and an x-axis.
